(19) United States
(12) Patent Application Publication
(10) Pub. No.: US 2008/0151788 A1
(43) Pub. Date: Jun. 26, 2008

(54) CONVERTING A WIRELESS SYSTEM DEPLOYMENT FROM ONE DUPLEXING SCHEME TO ANOTHER

(76) Inventor: Eamonn F. Gormley, Bellevue, WA (US)

Correspondence Address: HOLLAND & KNIGHT LLP, 10 ST. JAMES AVENUE, 11th Floor, BOSTON, MA, 02116-3889, US

(21) Appl. No.: 11/615,139

(22) Filed: Dec. 22, 2006

(51) Int. Cl. H04J 3/00; H04J 1/00

(52) U.S. Cl. 370/280; 370/281

(57) ABSTRACT

A method includes, in a wireless network including radios operating in a Frequency Division Duplexing (FDD) mode in wireless subscriber stations and wireless base stations, freeing a portion of spectrum to enable deployment of radios operating in a Time Division Duplexing (TDD) mode, replacing a first portion of FDD radios in the wireless subscriber stations and wireless base stations with H-FDD radios to avoid interference between FDD radios and TDD radios, utilizing a guard band frequency of the spectrum between the FDD radios and the TDD radios for operation of the H-FDD radios, and replacing FDD radios in a remaining portion of the wireless network with TDD radios.

### BACKGROUND

The present invention relates to wireless networks, and more particularly to converting a wireless system deployment from one duplexing scheme to another.

There are two primary duplexing schemes that are used in wireless communications systems, i.e., Frequency Division Duplexing (FDD) and Time Division Duplexing (TDD). In a FDD scheme, two radios in a system communicate with each other at the same time by transmitting on different frequencies. In a TDD scheme, two radios in a system use the same frequencies for their transmissions, but transmit at different times. The wireless industry is moving from the FDD scheme methodology to the TDD scheme methodology for broadband wireless deployments. Broadband wireless deployment is aimed at providing wireless access to data networks, with high data rates. One particular broadband wireless access technology is being standardized by IEEE 802.16 and is known as WiMAX.

There is no one piece of spectrum that is allocated for WiMAX. Even when people talk about WiMAX in the 2.5 GHz or 3.5 GHz licensed spectrum, they are talking about multiple frequency bands. For example, in the USA, Canada, and parts of Latin America, spectrum is available for broadband wireless access in the 2.3 GHz range and in the range 2.5 GHz to 2.7 GHz, but 2.4 GHz is unlicensed and used for WiFi and cordless phones. The 3.5 GHz band is really a hodge-podge of frequencies ranging from 3.3 GHz to 3.8 GHz.

The WiMAX forum has defined TDD and FDD profiles for 3.5 GHz in Europe, and is proposing TDD and FDD for 2.5 GHz also. What frequencies are allocated, and whether they are TDD or FDD, could even be a political decision taken by a regulating authority.

TDD systems can be deployed in FDD spectrum allocations, but if a TDD wireless network is deployed in adjacent frequencies to a FDD wireless network, both systems can cause high levels of interference with each other. An operator may already have a FDD system deployed, but will want to deploy a TDD network using the same, or adjacent frequencies.

### SUMMARY

The present invention provides methods and apparatus for wireless systems, and more particularly, for converting a wireless system deployment from one duplexing scheme to another.

In an aspect, the invention features a method including, in a wireless network including equipment operating in a Frequency Division Duplexing (FDD) mode, freeing a portion of spectrum to enable deployment of Half-Duplex Frequency Division Duplexing (H-FDD) equipment, and replacing a first portion of the FDD equipment with H-FDD equipment operating in H-FDD mode.

In embodiments, the FDD equipment can include one or more FDD base stations and one or more FDD subscriber stations. The H-FDD equipment can include one or more H-FDD base stations and one or more H-FDD subscriber stations. The freed portion of spectrum can be a guard band.

The method can include migrating some or all of the users of the FDD equipment to the H-FDD equipment operating in H-FDD mode in the freed portion of spectrum. The method can include deploying Time Division Duplexing (TDD) equipment in the wireless network, the TDD equipment including one or more TDD base stations and one or more TDD subscriber stations.

The method can include migrating the remaining users of the FDD equipment to the TDD equipment or to the H-FDD equipment operating in H-FDD mode and configuring the H-FDD equipment operating in H-FDD mode to operate in TDD mode.

In another aspect, the invention features a method including, in a wireless network including equipment operating in a Frequency Division Duplexing (FDD) mode in wireless subscriber stations and wireless base stations, freeing a portion of spectrum to enable deployment of Half-Duplex Frequency Division Duplexing (H-FDD) wireless subscriber stations and wireless base stations operating in a H-FDD mode, utilizing the free portion of spectrum for operation of the H-FDD wireless subscriber stations and the H-FDD wireless base stations, and migrating some or all of the users of the FDD equipment to the H-FDD wire subscriber stations and H-FDD wireless base stations.

In embodiments, the freed portion of spectrum can be a guard band.

The method can include deploying Time Division Duplexing (TDD) equipment in the wireless network, the TDD equipment including one or more TDD base stations and one or more TDD subscriber stations. The method can include migrating the remaining users of the FDD equipment to the TDD equipment or to the H-FDD equipment operating in H-FDD mode. The method can include reconfiguring the H-FDD equipment operating in H-FDD mode, to operate in TDD mode.

In still another aspect, the invention features a method including, in a wireless network including equipment operating in a Time Division Duplexing (TDD) mode in wireless subscriber stations and wireless base stations, freeing a portion of spectrum to enable deployment of Frequency Division Duplexing (H-FDD) wireless subscriber stations and wireless base stations operating in a H-FDD mode, utilizing the free portion of spectrum for operation of the FDD wireless subscriber stations and the FDD wireless base stations, and migrating some or all users of the TDD equipment to the FDD wireless subscriber stations and FDD wireless base stations operating in H-FDD mode.

In embodiments, the freed portion of spectrum can be a guard band.

The method can include deploying FDD equipment operating in FDD mode in the wireless network, the FDD equipment operating in FDD mode including one or more FDD base stations and one or more FDD subscriber stations. The method can include migrating the remaining users of the TDD equipment to the FDD equipment operating in FDD mode or to the FDD equipment operating in H-FDD mode. The method can include reconfiguring the FDD equipment operating in H-FDD mode, to operate in FDD mode.

The invention can be implemented to realize one or more of the following advantages.

The method enables an operator of a Frequency Division Duplexing (FDD) wireless network to migrate an entire FDD wireless network to a Time Division Duplexing (TDD) wireless network with minimal additional spectrum requirements. In some cases, no additional spectrum is required.

The method enables an operator of a FDD wireless system to migrate to a TDD wireless system in a controlled manner, while minimizing an impact to current customers throughout the upgrade.

The method results in reduced cost of migration from FDD to TDD because no new spectrum needs are leased/purchased.

Our method enables minimal impact on current customers using a FDD system, hence, minimal disruption to revenue stream from current customers.

Our method is used to migrate from a FDD deployment to a TDD deployment. This same method can be used for migrating from a TDD deployment to a FDD deployment. In the latter case, H-FDD equipment can be deployed initially to operate in TDD mode, and later switched to operate in H-FDD mode as the remainder of the network is deployed in FDD.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary wireless network.

FIG. 2 is a flow diagram.

FIG. 3 is a block diagram of an exemplary legacy Frequency Division Duplexing (FDD) wireless deployment.

FIG. 4 is a block diagram of an exemplary Half-Duplex Frequency Division Duplexing (H-FDD) deployment.

FIG. 5 is a block diagram of an exemplary hybrid deployment.

FIG. 6 is a block diagram of an exemplary Time Division Duplexing (TDD) wireless deployment.

Like reference numbers and designations in the various drawings indicate like elements.

### DETAILED DESCRIPTION

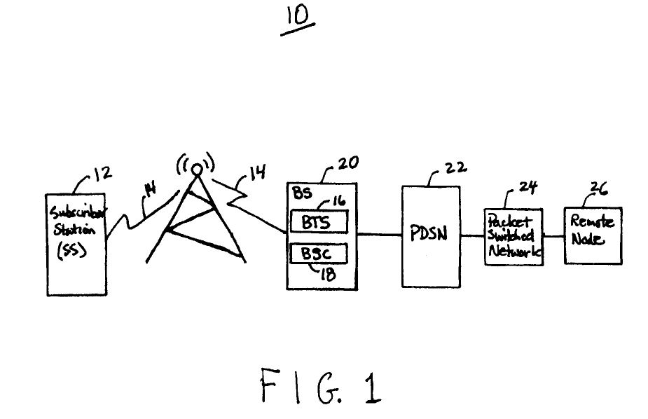

As shown in FIG. 1, an exemplary wireless network 10 includes a subscriber station (SS) 12 communicating over an air link 14 with a base transceiver station (BTS) 16 and in turn with a base station controller (BSC) 18. Here, the BTS 16 and BSC 18 cooperatively define a base station (BS) 20. The air link 14 is a radio-frequency portion of a circuit between the subscriber station 12 and base station 20. BSC 18 is coupled by a link to a packet data serving node (PDSN) 22, which, as a network access server, provides connectivity with a packet switched network 24, such as the Internet. A remote node 26 may in turn sit on or be accessible via the packet-switched network 24.

The subscriber station 12 can take various forms. For example, the subscriber station 12 can be a fixed wireless terminal, a cellular or personal communications services (PCS) telephone, a notebook computer or personal digital assistant (PDA) that includes or is connected with a cellular or PCS telephone or with a wireless communications card. Other examples are possible as well.

End-to-end communication is established from the subscriber station 12 to the remote node 26 over a packetized communication path including the air link 14 between the subscriber station 12 and the base station 20, the air link 14 between the base station 20 and the PDSN 22, and the packet-switched network 24 between the PDSN 22 and the remote node 26.

Wireless networks, such as the wireless network 10, can use one of various duplexing schemes, i.e., Frequency Division Duplexing (FDD) or Time Division Duplexing (TDD). As described above, in FDD, the base station and the SS in the wireless network 10 use different frequencies for their transmissions. In TDD, the base station and the SS in the wireless network 10 use the same frequencies for their transmissions, but transmit at different times.

Another duplexing scheme is known as Half-Duplex Frequency Division Duplexing (H-FDD). H-FDD is similar to FDD in that an H-FDD radio uses different frequencies for transmission and reception. H-FDD is similar to TDD in that an H-FDD radio transmits and receives at different times.

While H-FDD radios generally use different frequencies for transmission and reception of radio signals, it is possible to design an H-FDD radio that optionally behaves as a TDD radio by enabling transmit and receive frequencies to be set to the same frequency. In this case, we say that the H-FDD radio is configured to operate in TDD mode.

It is also possible for a FDD radio to operate in a H-FDD mode by instructing the radio to transmit and receive at different times. In this case, we say that the FDD radio is operating in H-FDD mode.

Each of the duplexing schemes has advantages and disadvantages. In wireless cellular networks where voice is the dominant application, the FDD scheme is used almost exclusively. Since voice traffic is considered “symmetric,” allocating an equal amount of electromagnetic spectrum to an uplink and a downlink enables efficient utilization of the electromagnetic spectrum. Here, uplink refers to a transmission path from a subscriber station to a base station (e.g., cell site), and downlink refers to a transmission path from a base station to a subscriber station (e.g., cell phone).

Allocating an equal amount of electromagnetic spectrum to an uplink and a downlink can be done with TDD systems, but there are other advantages to using FDD, such as better link budget, better immunity to interference, easier planning for cellular networks, and so forth. While FDD has its advantages over TDD, developments in wireless technologies and in the wireless marketplace are making TDD more attractive. Among the reasons to move to TDD are asymmetric data, smart antennas/Multiple-input multiple-output (MIMO) antenna systems, and cost, for example.

With the advent of packet data networks, an assumption that data traffic is symmetric in the downlink and uplink is no longer valid. Analysis of broadband packet data networks has shown that for packet data, there is typically more traffic on the downlink than on the uplink. With FDD, the uplink and downlink spectrum allocations are fixed at 50% in each direction. With TDD, the amount of time allocated to the downlink compared to the amount of time allocated to the uplink can be set to values other than 50% for each direction (e.g., 70%/30%). Further, the amount of time allocated for each direction can be changed dynamically in response to the amount of data traffic that needs to be transported in each direction.

Smart antennas and MIMO technologies are used to improve the performance of the wireless network 10. These technologies are generally easier to implement with TDD links than with FDD links. Since, in TDD, the same channel is used for the downlink and the uplink, the wireless channel has reciprocity. Measurements of the phase and amplitude variations in a wireless channel that are made by the radio receiver can be used by the radio transmitter to improve the performance of the link.

There are cost savings that can be realized by using TDD in place of FDD. FDD radios typically use the same antenna for transmit and receive. When this is done, it is necessary to use a duplexer to isolate the transmitter and receiver. In a TDD radio, no duplexer is required. Instead a radio frequency (RF) switch, which is less expensive, is used to switch the antenna between the transmitter and the receiver.

Many wireless network operators have currently deployed a wireless network system that uses FDD radios, with voice as the primary application. These wireless network operators often desire to upgrade their wireless networks so that they can generate additional revenue from broadband data services, such as Internet access. Current FDD wireless network operators are attracted by TDD equipment that can provide the types of services that the operators want to sell, and that also bring the benefits of increased utilization of limited and expensive RF spectrum resources.

Wireless network operators cannot simply deploy a TDD wireless system in frequencies that are adjacent to a FDD wireless system. It is necessary to separate the two systems, either physically, or by maintaining a separation in frequency.

One solution to providing a TDD network is to acquire additional spectrum for the planned TDD network. However, this may not be a feasible solution because additional spectrum may not be available. Even if additional spectrum is available, an incumbent operator may not be able to acquire any of this spectrum due to governmental regulations that may be in place to promote competition among wireless providers. Additional spectrum may also be prohibitively expensive.

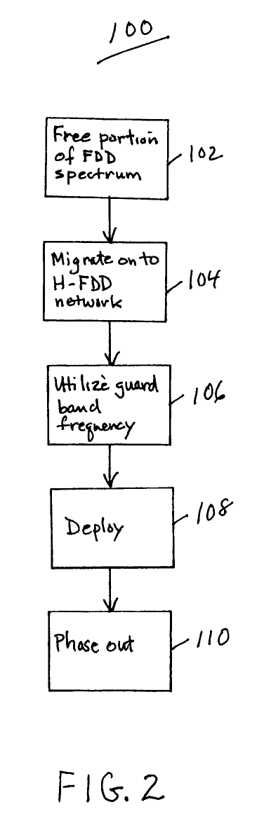

To enable changing a FDD wireless system to a TDD wireless system, our deployment process 100 (FIG. 2) initially utilizes H-FDD radios at a base station (BS) and subscriber station (SS) that can also be operated in Half-Duplex Frequency Division Duplexing (H-FDD) mode to avoid interference between the legacy FDD wireless system and the initial deployment of TDD radios. The H-FDD radios operating in H-FDD mode use the legacy FDD downlink frequencies for base station to subscriber station transmissions and the legacy FDD uplink frequencies for subscriber station to base station transmissions.

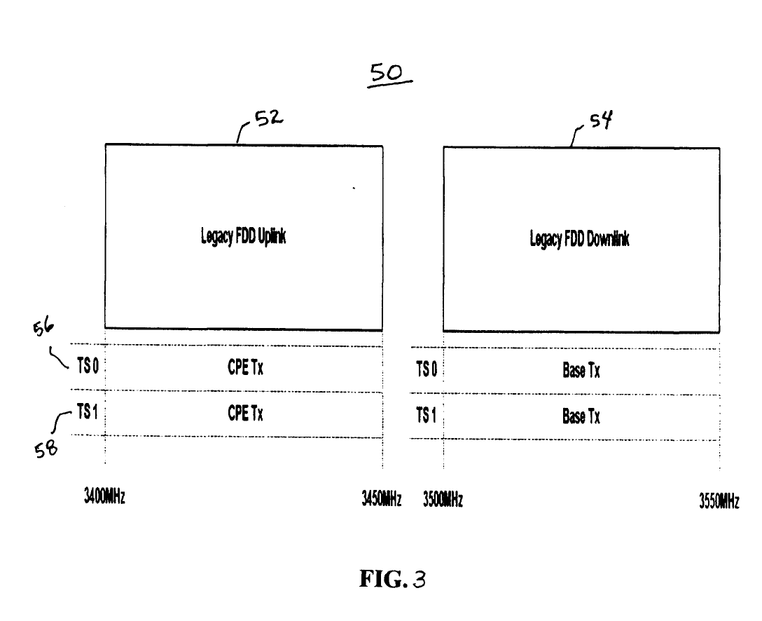

As shown in FIG. 3, an exemplary legacy FDD wireless deployment 50 includes a legacy FDD uplink portion 52 and a legacy FDD downlink portion 54. Deployment process 100 enables an operator/owner to covert a legacy FDD wireless network represented by legacy FDD wireless deployment 50 to a TDD wireless deployment. In FIG. 3, “TS0” 56 and “TS1” 58 refer to TDD time slots. In time slot TS0 56, a TDD base station (BS) transmits, i.e., Base Tx. In a time slot TS1 58, the TDD Customer Premises Equipment (CPE) transmits, i.e., CPE Tx. In the FDD network, the base station and CPE transmit in both timeslots 52, 54, but on different frequencies.

Deployment process 100 includes freeing (102) a portion of the FDD spectrum used in FDD wireless deployment 50 so that a H-FDD system can be deployed in the freed spectrum. These H-FDD radios are initially configured to operate in the H-FDD mode of operation.

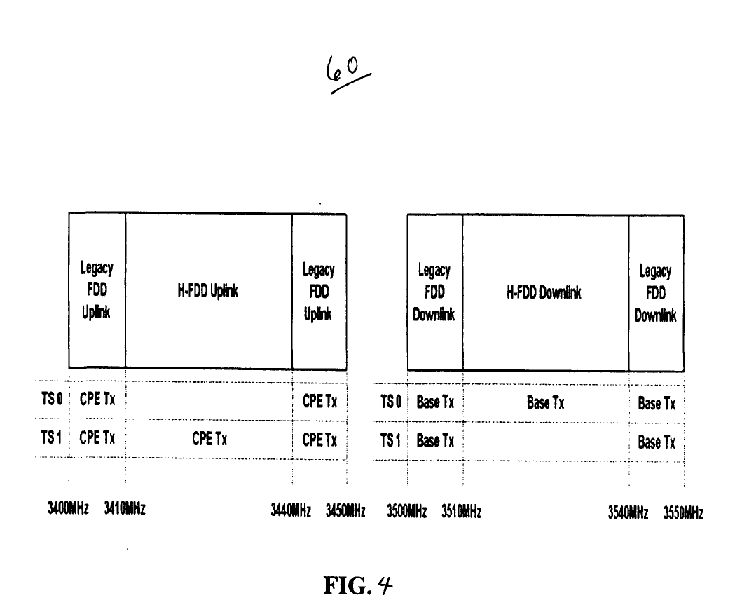

As H-FDD equipment is being deployed, FDD subscribers can be migrated (104) onto the H-FDD network, which frees up additional spectrum, resulting in an H-FDD deployment 60 as shown in FIG. 4. Here, a legacy FDD uplink transmission utilizes a spectrum from 3400 MHz to 3410 MHz and 3440 Mhz to 3450 MHz, and a H-FDD uplink transmission utilizes a spectrum from 3410 MHz to 3440 MHz. A legacy FDD downlink transmission utilizes a spectrum from 3500 MHz to 3510 MHz and 3540 MHz to 3550 MHz, while a H-FDD downlink transmission utilizes a spectrum from 3510 MHz to 3540 MHz.

Eventually, enough spectrum may be freed (102) to enable TDD equipment to be deployed (108) within the network.

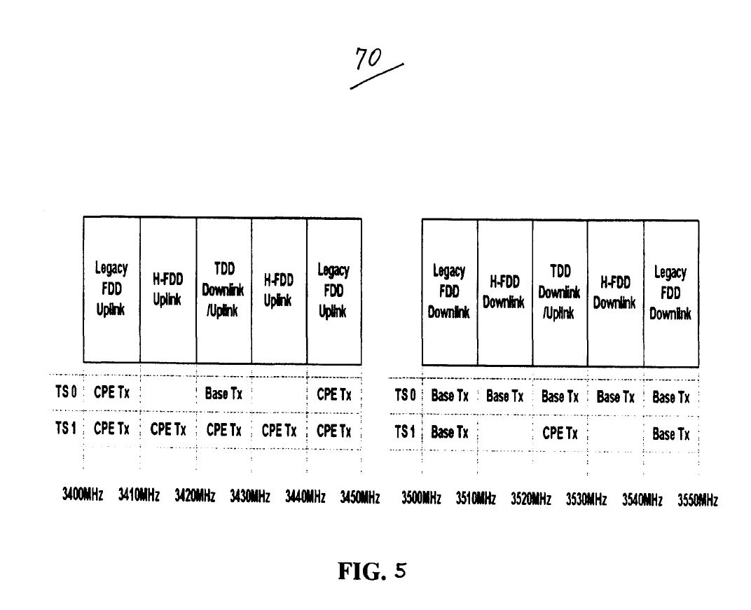

Deployment process 100 utilizes (106) a guard band frequency of the spectrum between the TDD equipment and the FDD equipment, enabling H-FDD equipment to remain operational. Typically, it is not feasible to deploy FDD or TDD equipment in guard band frequencies between the FDD and TDD systems. However, an H-FDD system that has the same timing as a TDD system can be safely deployed in the guard band frequency without causing any interference to the FDD and TDD systems, resulting in a hybrid deployment 70 as shown in FIG. 5.

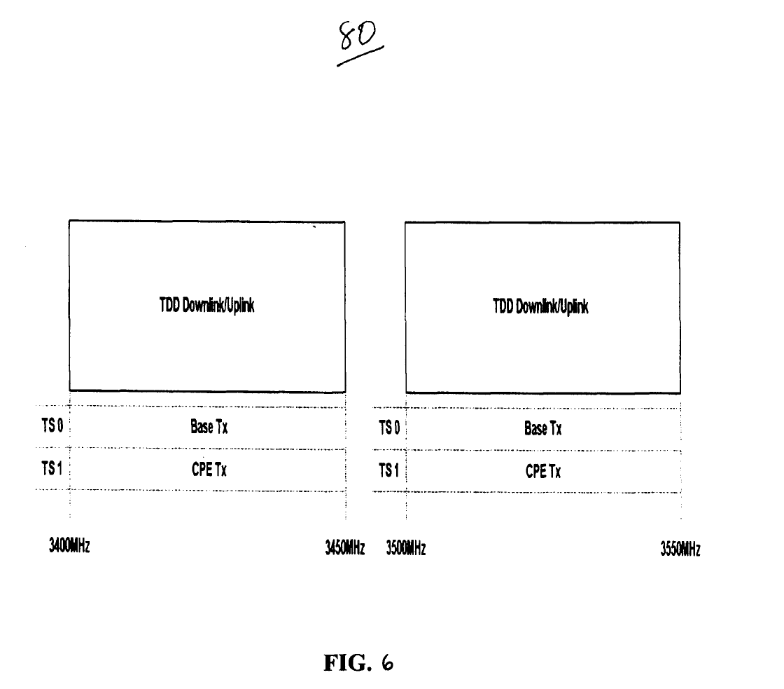

Deployment process 100 phases out (110) FDD equipment completely and the H-FDD equipment can be re-configured to operate in TDD mode as shown in FIG. 6 as deployment 80. More particularly, at the base station, the operator can independently select the frequencies required for the uplink and the downlink. For H-FDD mode of operation of the H-FDD equipment, different frequencies are chosen. For TDD mode of operation of the H-FDD equipment, the same frequency is chosen for uplink and downlink. The subscriber station scans for a base station transmitting on a downlink frequency. Once a base station has been identified, the subscriber station determines which uplink frequency to use. In one example, the base station can transmit the uplink frequency to the subscriber station on either a broadcast channel or in a message dedicated to that subscriber station alone. In another example, the subscriber station can try to send a message to the base station on either the same frequency or on a different frequency. If the uplink messaging fails on one frequency, then the subscriber station can try a different frequency.

While deployment process 100 enables the operator to migrate from a FDD network deployment to a TDD network deployment, a similar approach can be used for an operator migrating from a TDD network to a FDD network. In this example, H-FDD radios are operated in a TDD mode of operation to avoid interference with a legacy TDD equipment. Eventually, base station FDD radios will operate in full FDD mode. Subscriber station radios can also operate in full FDD mode, or may continue to operate in H-FDD mode.

The above described our method used to migrate from a FDD deployment to a TDD deployment. This same method can be used for migrating from a TDD deployment to a FDD deployment. In the latter case, H-FDD equipment can be deployed initially to operate in TDD mode, and later switched to operate in H-FDD mode as the remainder of the network is deployed in FDD.

It is to be understood that the foregoing description is intended to illustrate and not to limit the scope of the invention, which is defined by the scope of the appended claims. Other embodiments are within the scope of the following claims.

What is claimed is:

1. A method comprising:
in a wireless network comprising equipment operating in a Frequency Division Duplexing (FDD) mode, freeing a portion of spectrum to enable deployment of Half-Duplex Frequency Division Duplexing (H-FDD) equipment; and
replacing a first portion of the FDD equipment with H-FDD equipment operating in H-FDD mode.

2. The method of claim 1 wherein the FDD equipment comprises one or more FDD base stations and one or more FDD subscriber stations.

3. The method of claim 1 wherein the H-FDD equipment comprises one or more H-FDD base stations and one or more H-FDD subscriber stations.

4. The method of claim 1 wherein the freed portion of spectrum is a guard band.

5. The method of claim 2 further comprising migrating some or all of the users of the FDD equipment to the H-FDD equipment operating in H-FDD mode in the freed portion of spectrum.

6. The method of claim 5 further comprising deploying Time Division Duplexing (TDD) equipment in the wireless network, the TDD equipment comprising one or more TDD base stations and one or more TDD subscriber stations.

7. The method of claim 6 further comprising migrating the remaining users of the FDD equipment to the TDD equipment or to the H-FDD equipment operating in H-FDD mode.

8. The method of claim 7 further comprising reconfiguring the H-FDD equipment operating in H-FDD mode to operate in TDD mode.

9. A method comprising:
in a wireless network comprising equipment operating in a Frequency Division Duplexing (FDD) mode in wireless subscriber stations and wireless base stations, freeing a portion of spectrum to enable deployment of Half-Duplex Frequency Division Duplexing (H-FDD) wireless subscriber stations and wireless base stations operating in a H-FDD mode;
utilizing the free portion of spectrum for operation of the H-FDD wireless subscriber stations and the H-FDD wireless base stations; and
migrating some or all of the users of the FDD equipment to the H-FDD wire subscriber stations and H-FDD wireless base stations.

10. The method of claim 9 wherein the freed portion of spectrum is a guard band.

11. The method of claim 9 further comprising deploying Time Division Duplexing (TDD) equipment in the wireless network, the TDD equipment comprising one or more TDD base stations and one or more TDD subscriber stations.

12. The method of claim 11 further comprising migrating the remaining users of the FDD equipment to the TDD equipment or to the H-FDD equipment operating in H-FDD mode.

13. The method of claim 12 further comprising reconfiguring the H-FDD equipment operating in H-FDD mode, to operate in TDD mode.

14. A computer program product, tangibly embodied in an information carrier, for deploying Half-Duplex Frequency Division Duplexing (H-FDD) equipment into a legacy Frequency Division Duplexing (FDD) system, the computer program product being operable to cause data processing apparatus to:
free a portion of spectrum to enable deployment of Half-Duplex Frequency Division Duplexing (H-FDD) equipment; and
replace a first portion of FDD equipment with H-FDD equipment operating in H-FDD mode.

15. The computer program product of claim 14 wherein the FDD equipment comprises one or more FDD base stations and one or more FDD subscriber stations.

16. The computer program product of claim 14 wherein the H-FDD equipment comprises one or more H-FDD base stations and one or more H-FDD subscriber stations.

17. The computer program product of claim 14 wherein the freed portion of spectrum is a guard band.

18. The computer program product of claim 14 further operable to cause data processing apparatus to:
migrate some or all of the users of the FDD equipment to the H-FDD equipment operating in H-FDD mode.

19. The computer program of claim 18 further operable to cause data processing apparatus to:
deploy Time Division Duplexing (TDD) equipment in the wireless network, the TDD equipment comprising one or more TDD base stations and one or more TDD subscriber stations.

20. The computer program of claim 19 further operable to cause data processing apparatus to:
migrate the remaining users of the FDD equipment to the TDD equipment or to the H-FDD equipment operating in H-FDD mode.

21. The computer program product of claim 20 further operable to cause data processing apparatus to:
reconfigure the H-FDD equipment operating in H-FDD mode to operate in TDD mode.

22. A method comprising:
in a wireless network comprising equipment operating in a Time Division Duplexing (TDD) mode in wireless subscriber stations and wireless base stations, freeing a portion of spectrum to enable deployment of Frequency Division Duplexing (FDD) wireless subscriber stations and wireless base stations operating in a H-FDD mode;
utilizing the free portion of spectrum for operation of the FDD wireless subscriber stations and the FDD wireless base stations; and
migrating some or all users of the TDD equipment to the FDD wireless subscriber stations and FDD wireless base stations operating in H-FDD mode.

23. The method of claim 22 wherein the freed portion of spectrum is a guard band.

24. The method of claim 22 further comprising deploying FDD equipment operating in FDD mode in the wireless network, the FDD equipment operating in FDD mode comprising one or more FDD base stations and one or more FDD subscriber stations.

25. The method of claim 24 further comprising migrating the remaining users of the TDD equipment to the FDD equipment operating in FDD mode or to the FDD equipment operating in H-FDD mode.

26. The method of claim 25 further comprising reconfiguring the FDD equipment operating in H-FDD mode, to operate in FDD mode.
